(19) United States
(12) Patent Application Publication
(10) Pub. No.: US 2014/0353191 A1
(43) Pub. Date: Dec. 4, 2014

(54) HAND TOOL CASE

(71) Applicants: John DeCicco, Elmhurst, IL (US); Brett Huber, Arlington Heights, IL (US)

(72) Inventors: John DeCicco, Elmhurst, IL (US); Brett Huber, Arlington Heights, IL (US)

(21) Appl. No.: 14/359,550

(22) PCT Filed: Nov. 9, 2012
(86) PCT No.: PCT/EP2012/072303

§ 371 Date: May 20, 2014

(30) Foreign Application Priority Data
Nov. 22, 2011 (DE) 10 2011 086 874.7

(51) Int. Cl. B25H 3/00; B25H 3/02

(52) U.S. Cl. CPC B25H 3/006; B25H 3/022
USPC 206/373

(57) ABSTRACT

A hand tool case includes at least one first inductive charge receiving area and at least one first adjustment unit which is provided for changing a position and/or a size of at least the first inductive charge receiving area.

### BACKGROUND OF THE INVENTION

1. Field of the Invention

The present invention relates to a hand tool case having an induction charge receiving area.

2. Description of the Related Art

Hand tool cases have previously been provided.

### BRIEF SUMMARY OF THE INVENTION

The present invention relates to a hand tool case having at least one first inductive charge receiving area, and at least one first adjustment unit which is provided for changing a position and/or a size at least of the first inductive charge receiving area. A “hand tool case” is understood in particular to mean a transport container which is provided for accommodating at least one hand tool battery which is provided for being inductively charged, and preferably at least one hand tool. In particular, the hand tool case has an at least essentially cuboidal shape. The statement that an object has an “essentially cuboidal” design is understood in particular to mean that there is at least one cuboid which is situated completely within the object and which encompasses at least 70%, in particular at least 80%, advantageously at least 90%, preferably at least 95%, of the points of the object. In particular, in at least one main direction of extension, the “height,” the hand tool case has an extension which corresponds to 70% maximum, in particular 50% maximum, advantageously 30% maximum, preferably 10% maximum, of an extension along a further main direction of extension, the “width.” Alternatively, designs of the hand tool case having an at least essentially cube-like shape are conceivable.

A “main direction of extension” is understood in particular to mean a main axis of inertia. Two main directions of extension are preferably situated perpendicularly with respect to one another. The hand tool case preferably has an extension of at least 20 cm, in particular at least 25 cm, advantageously at least 35 cm, and 80 cm maximum, in particular 70 cm maximum, advantageously 50 cm maximum, along the width. The hand tool case preferably has an extension of at least 5 cm, in particular at least 7 cm, advantageously at least 9 cm, and 20 cm maximum, in particular 15 cm maximum, advantageously 12 cm maximum, along the height.

In particular, on at least one lateral surface the hand tool case has a handle which in particular is provided for carrying and/or hanging the hand tool case in a vertical orientation in which the height of the hand tool case is oriented at least essentially in parallel to the horizontal. In particular, the hand tool case has at least one handle situated on a top side, in particular on the lid, and/or at least two handles which are situated on opposite lateral surfaces and which in particular are provided for carrying and/or hanging the hand tool case in a horizontal orientation in which the height of the hand tool case is oriented at least essentially perpendicularly with respect to the horizontal. The term “essentially parallel” is understood in particular to mean an angle less than 30°, in particular less than 15°, advantageously less than 5°, preferably less than 1°. The term “essentially perpendicularly” is understood in particular to mean an angle which deviates from 90° by less than 30°, in particular by less than 15°, advantageously by less than 5°, preferably by less than 1°.

In particular, the handles are pivotable and preferably are retractable into the hand tool case. In particular, the hand tool case has at least two housing parts which form an outer delimitation of the hand tool case.

In particular, the housing parts are connected to one another via a hinge mechanism and/or a slide mechanism. In particular, at least one of the housing parts is designed as a shell, and, together with at least one interior structuring element which is situated in the housing part which is designed as a shell and/or is designed in one piece with the housing part, is provided for providing at least one inductive charge receiving area. In particular, at least one of the housing parts is designed as a lid. In particular, the housing part designed as a lid is provided for closing off the hand tool case in a watertight manner. An “inductive charge receiving area” is understood in particular to mean a receiving area of the hand tool case which is provided for accommodating at least one hand tool battery and to assist in inductive charging of a hand tool battery which is inserted into the inductive charge receiving area.

In particular, the inductive charge receiving area is provided for allowing charging of the hand tool battery with an efficiency of at least 70%, in particular at least 80%, advantageously at least 90%, preferably at least 95%. In particular, the inductive charge receiving area allows inductive charging of the hand tool battery through a wall of the hand tool case. In particular, the inductive charge receiving area is provided for accommodating a hand tool battery which is mechanically and/or electrically connected to a hand tool and/or integrated into a hand tool. The housing parts, at least those situated in close proximity to the inductive charge receiving area, are preferably made of an insulating material in order to avoid small losses during energy transmission via induction. The term “provided” is understood in particular to mean specially designed and/or equipped. The statement that a hand tool battery is provided for being “inductively” charged is understood in particular to mean that the hand tool battery has at least one charging coil. In addition, the hand tool battery has at least one coupling site which is provided for mechanically connecting the hand tool battery to a hand tool. In particular, the coupling site is part of a detent mechanism and/or twist-on mechanism. A “charging coil” is understood in particular to mean a coil having at least one twisted, in particular wound, electrical conductor which is provided for sending and/or preferably for receiving, in at least one operating state, energy for charging and/or discharging, in particular of at least one, preferably electrochemical, energy storage unit of the hand tool battery. Alternatively, the charging coil is formed by a printed conductor situated on a printed circuit board. The charging coil is preferably provided for converting an electrical alternating current into an alternating magnetic field and/or vice versa. In particular, the charging coil is provided for supplying received energy directly to a consumer, in particular via a voltage transformer.

A system including a hand tool battery and a charging device and/or a hand tool preferably has at least two mutually coordinated charging coils which are spatially separable by an operator, in at least one operating state at least one charging coil being provided for generating an alternating magnetic field which induces an electrical alternating current in at least one additional charging coil. In particular, the hand tool battery has an electronics system which is provided for converting an alternating current which is induced in the charging coil into a direct current which is storable in the energy storage unit, and/or for converting a direct current which is withdrawn from the energy storage unit into an alternating current in order to thus feed the charging coil and transmit energy to a corresponding charging coil. In particular, the adjustment unit is provided for being adjusted by an operator, in particular a tension of a spring element being at least essentially dispensed with. The statement that a tension of a spring element is largely dispensed with is understood in particular to mean that an extension of a spring element is changed by a length of 10 mm maximum, in particular 5 mm maximum, advantageously 3 mm maximum, preferably 1 mm maximum. In particular, increased flexibility, in particular due to adaptability to different sizes of hand tool batteries and/or different sizes of hand tools, may be achieved. In particular, effective energy transmission may be achieved.

In addition, it is provided that at least the first inductive charge receiving area is situated at least partially in close proximity to a wall. A “wall” is understood in particular to mean an integral part of the hand tool case which is provided for forming an outer delimitation of the hand tool case. In particular, the wall has a material thickness of less than 8 mm, in particular less than 5 mm, advantageously less than 3 mm, preferably less than 2 mm. The wall is preferably formed by a top side and/or preferably a bottom side of the hand tool case. A “bottom side” of the hand tool case is understood in particular to mean a side which is opposite from the lid. In particular, the bottom side is oriented at least essentially perpendicularly with respect to the height. Alternatively, an arrangement of the charging coil on a front side which is situated opposite from the rear side and which in particular has a handle, and which in particular is situated close to the handle, is conceivable. A “rear side” of the hand tool case is understood in particular to mean an outer side which has no handle. In particular, the rear side has stands. An “outer side” of the hand tool case is understood in particular to mean a side which is oriented at least essentially in parallel to the height of the hand tool case. The statement that the inductive charge receiving area is stored at least “partially” in “close proximity” to a wall is understood in particular to mean that at least 2% by volume, in particular at least 5% by volume, preferably at least 10% by volume, of the inductive charge receiving area, and in particular at least 10% by volume, advantageously at least 30% by volume, preferably at least 50% by volume, of the charging coil of a hand tool battery which is inserted into the inductive charge receiving area, are situated at a distance of 25 mm maximum, in particular 20 mm maximum, advantageously 15 mm maximum, preferably 10 mm maximum, from the wall. In particular, effective energy transmission may be achieved.

In addition, it is provided that at least the first adjustment unit is provided for pressing at least one hand tool battery which is inserted into at least the first inductive charge receiving area against the at least one wall. The statement that the hand tool battery is “pressed” against the wall is understood in particular to mean that the hand tool battery contacts the wall at at least one point. In particular, the adjustment unit is provided for generating a force with which the hand tool battery acts on the wall. In particular, a small distance between corresponding charging coils, and thus efficient charging and/or compliance with EMC guidelines, may be achieved.

At least the first adjustment unit preferably has at least one spring element. A “spring element” is understood in particular to mean a macroscopic element which has at least one extension which in a normal operating state is elastically changeable by at least 10%, in particular by at least 20%, preferably by at least 30%, and particularly advantageously by at least 50%, and which in particular generates a counterforce which acts against the change, and which is a function of a change in the extension and which preferably is proportional to the change. An “extension” of an element is understood in particular to mean a maximum distance between two points of a perpendicular projection of the element onto a plane. A “macroscopic element” is understood in particular to mean an element having an extension of at least 1 mm, in particular at least 5 mm, and preferably at least 10 mm. In particular, the spring element is designed as a coil spring, as a foam pad, and/or as a rubber spring. Alternatively, other types of springs which appear suitable to those skilled in the art are conceivable. The spring element is preferably provided for generating a force with which the hand tool battery acts on the wall. In particular, the spring element is provided for being tensioned by an operator during and/or after insertion of the hand tool battery. In particular, a small distance between corresponding charging coils, and thus efficient charging and/or compliance with EMC guidelines, may be achieved.

In addition, it is provided that the adjustment unit is at least partially formed by the wall. In particular, the wall is designed as a spring element and/or as a flexible, in particular elastically deformable, skin. In particular, good contact of the hand tool battery with the wall may be achieved.

In addition, it is provided that the hand tool case has at least one second inductive charge receiving area. In particular, increased flexibility may be achieved. In particular, the first inductive charge receiving area is provided for accommodating a hand tool with a hand tool battery fastened thereto. In particular, the second inductive charge receiving area is provided for accommodating a hand tool battery which is provided as a replacement battery.

Alternatively, it is conceivable for both inductive charge receiving areas to be provided for accommodating in each case a hand tool battery which is coupled to a hand tool, or only a loose hand tool battery in each case. The first adjustment unit is preferably provided for simultaneously changing sizes and/or positions of the at least two inductive charge receiving areas. In particular, a simple design may be achieved. In particular, the hand tool case has at least one interior structuring element in which the inductive charge receiving areas are situated, and which is provided for having its position in the hand tool case changed. In particular, the adjustment unit is situated between the interior structuring element and at least one housing part of the hand tool case. Alternatively, the hand tool case has a second adjustment unit which is provided for adapting a size and/or a position at least of the second inductive charge receiving area. It may be achieved in particular that different sizes of hand tool batteries, in particular having different capacities, may be simultaneously securely transported and/or inductively charged in the hand tool case.

Moreover, a system including a hand tool case according to the present invention, a hand tool battery according to the present invention, and a charging station are provided.

### BRIEF DESCRIPTION OF THE DRAWINGS

FIG. 1 shows a system according to the present invention including a hand tool case according to the present invention and a hand tool battery according to the present invention in a schematic illustration.

FIG. 2 shows an alternative system according to the present invention in a schematic illustration.

FIG. 3 shows another alternative system according to the present invention in a schematic illustration.

### DETAILED DESCRIPTION OF THE INVENTION

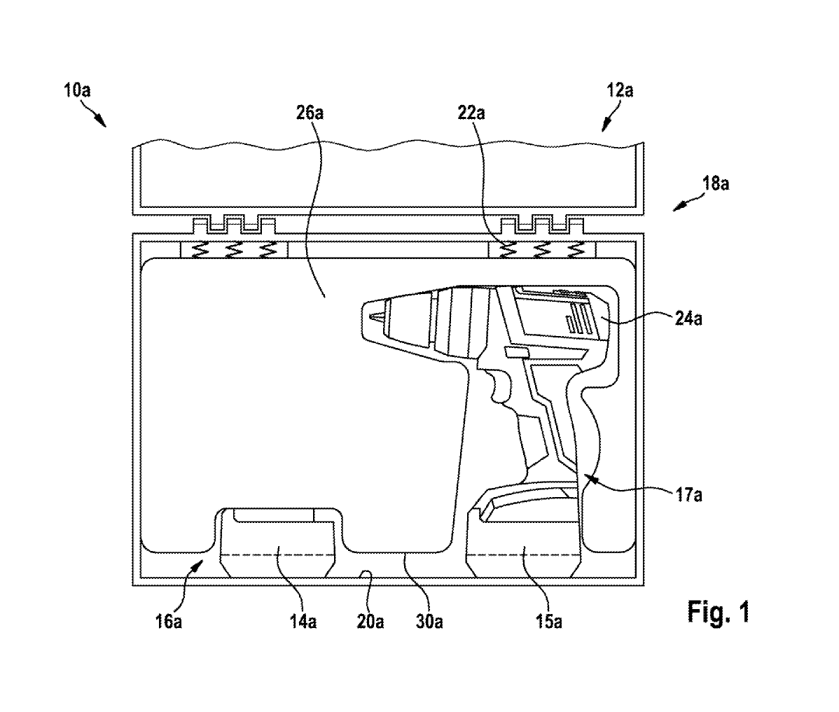

FIG. 1 shows a system 10a including a hand tool case 12a and two hand tool batteries 14a, 15a. Hand tool case 12a has a wall 20a, a first inductive charge receiving area 16a, and a first adjustment unit 18a which is provided for minimizing a distance between a hand tool battery 14a, which is inserted into first inductive charge receiving area 16a, and wall 20a. First inductive charge receiving area 16a is situated partially in close proximity to wall 20a. First adjustment unit 18a is provided for pressing hand tool battery 14a which is inserted into first inductive charge receiving area 16a against wall 20a. First adjustment unit 18a has two spring units, each having three spring elements 22a. First adjustment unit 18a is provided for changing a position and a size of inductive charge receiving area 16a. Hand tool case 12a has a second inductive charge receiving area 17a which is provided for accommodating a hand tool 24a having a connected hand tool battery 15a. First adjustment unit 18a is provided for changing a position and a size of first inductive charge receiving area 16a. Wall 20a is formed by a rear side of hand tool case 12a. Spring elements 22a are formed by coiled compression springs. Hand tool case 12a has an interior structuring element 26a in which inductive charge receiving areas 16a, 17a are formed. Interior structuring element 26a is part of adjustment unit 18a. Adjustment unit 18a is providing for pushing interior structuring element 26a together with hand tool batteries 14a, 15a inserted therein in the direction of wall 20a. Adjustment unit 18a is provided for generating a force which hand tool batteries 14a, 15a exert on wall 20a. Inductive charge receiving areas 16a, 17a are provided for accommodating hand tool batteries 14a, 15a, respectively, which protrude beyond a boundary 30a of interior structuring element 26a, so that hand tool batteries 14a, 15a may be pressed against wall 20a. Adjustment unit 18a is provided for being fitted with hand tool batteries of different sizes, whereby hand tool batteries which are inserted at the same time should have the same size in order to allow efficient charging of both hand tool batteries. In the case of small hand tool batteries (indicated by a dashed line), adjustment unit 18a is provided for pushing interior structuring element 26a together with hand tool batteries 14a, 15a farther in the direction of wall 20a than in the case of large hand tool batteries 14a, 15a.

In addition to adjustment unit 18a, padding elements which are used for securely storing hand tool batteries 14a, 15a may be situated in inductive charge receiving areas 16a, 17a. Hand tool batteries 14a, 15a each have a charging coil on the side of hand tool battery 14a, 15a facing wall 20a.

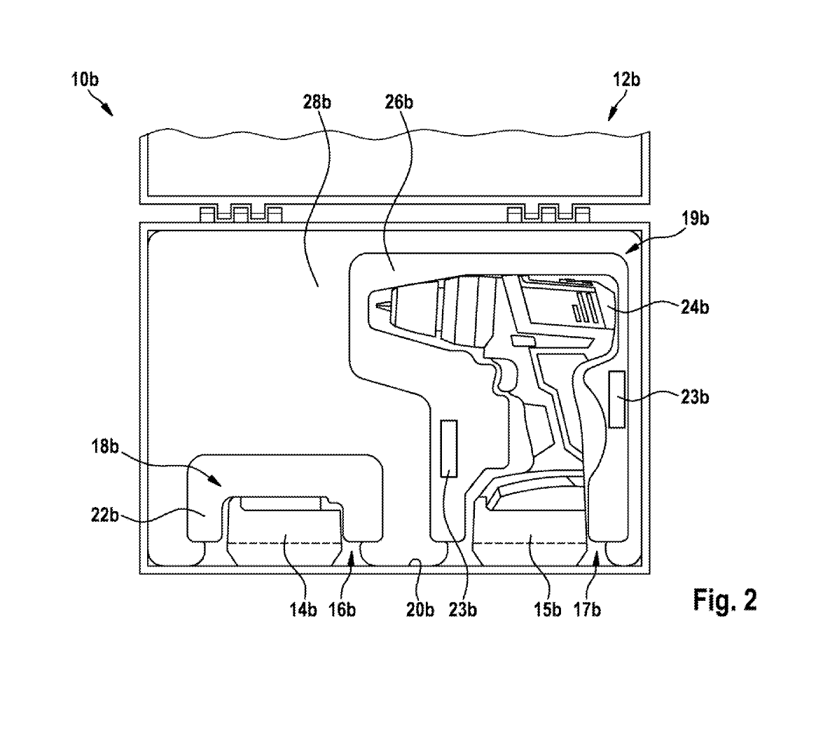

Three further exemplary embodiments of the present invention are shown in FIGS. 2 through 4. The following descriptions and the drawings are limited essentially to the differences between the exemplary embodiments; with regard to components denoted in the same way, in particular components having the same reference numerals, reference may basically also be made to the drawings and/or the description of the other exemplary embodiments, in particular for FIG. 1. To differentiate between the exemplary embodiments, the letter “a” is added as a suffix to the reference numerals of the exemplary embodiment in FIG. 1. In the exemplary embodiments in FIGS. 2 through 4, the letter “a” is replaced by the letters “b” through “d,” respectively.

FIG. 2 shows a system 10b including a hand tool case 12b which has an interior structuring element 28b. Interior structuring element 28b is inserted at a fixed position with respect to housing parts of hand tool case 12b. Interior structuring element 28b forms two inductive charge receiving areas 16b, 17b. A first adjustment unit 18b is situated in first inductive charge receiving area 16b. First adjustment unit 18b is provided for pressing a hand tool battery 14b against a wall 20b of hand tool case 12b. First adjustment unit 18b is formed by a spring element 22b which is designed as foam. Inductive charge receiving area 16b is provided for allowing hand tool batteries of different sizes to be accommodated. In the case of smaller hand tool batteries, the foam of first adjustment unit 18b is compressed to a lesser degree than in the case of large batteries. A second adjustment unit 19b is situated in second inductive charge receiving area 17b. Second adjustment unit 19b has an interior structuring element 26b which is situated movably with respect to interior structuring element 28b, and which is provided for storing an inserted hand tool 24b with a connected hand tool battery 15b. Second adjustment unit 19b also has spring elements 23b which are provided for bracing interior structuring elements 26b, 28b against one another and generating a force with which hand tool battery 15b acts on wall 20b. By inserting batteries of different sizes, interior structuring elements 26b, 28b are displaced against one another to different degrees. As an alternative and/or in addition to spring elements 23b, interior structuring elements 26b, 28b may have form-fit means and/or elements via which interior structuring elements 26b, 28b are fastenable in predefined positions relative to one another in order to securely accommodate different sizes of hand tool batteries.

As an alternative to an embodiment as foam, adjustment unit 18b may be formed by an additional interior structuring element which via spring elements may be braced against interior structuring element 26b.

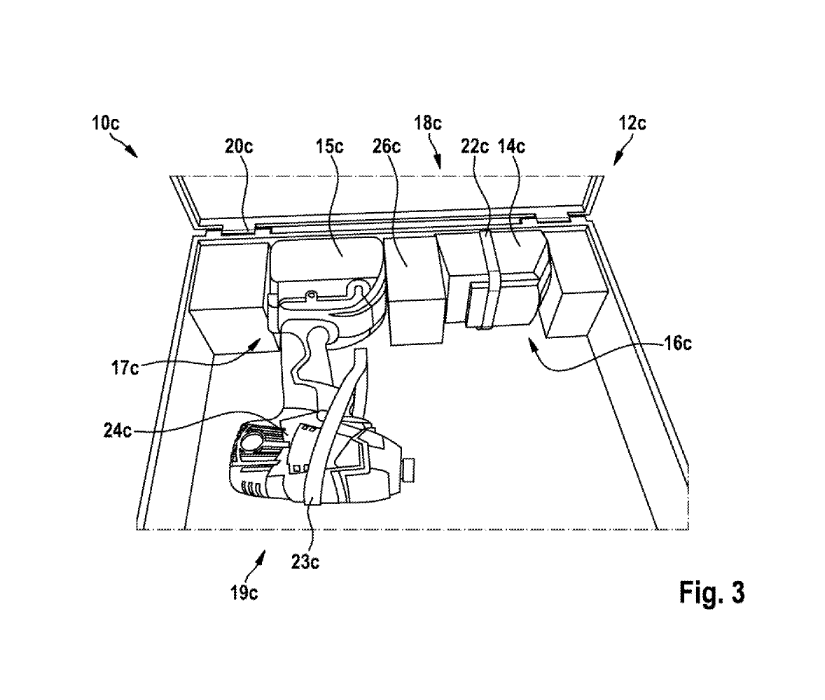

FIG. 3 shows a system 10c including a hand tool case 12c and two hand tool batteries 14c, 15c. Hand tool battery 15c is coupled to a hand tool 24c. Hand tool case 12c has an interior structuring element 26c which is provided for laterally guiding hand tool batteries 14c, 15c. Hand tool case 12c has two adjustment units 18c, 19c which are provided for pressing hand tool batteries 14c, 15c, respectively, against a wall 20c. Adjustment units 18c, 19c have a spring element 22c, 23c, respectively, which is designed as a rubber spring which is formed as a loop and connected at both ends to hand tool case 12c. Alternatively, at least one end, in particular both ends, of spring elements 22c, 23c may be connected to interior structuring element 26c. By inserting hand tool battery 14c, or hand tool battery 15c which is coupled to hand tool 24c, the particular rubber spring is stretched and generates a force with which hand tool battery 14c, 15c acts against wall 20c.

As an alternative to the rubber spring, embodiments having a hook-and-loop strip and/or other elastic bands and/or other embodiments which appear suitable to those skilled in the art are conceivable. In addition, a band which in particular is static, i.e., having little or no elasticity, is conceivable which has detent elements, in particular a hook or holes comparable to a belt, which may be engaged with corresponding detent points of the hand tool case.

1-9. (canceled)

10. A hand tool case, comprising:
at least one first inductive charge receiving area; and
at least one first adjustment unit for changing at least one of a position and a size of at least the first inductive charge receiving area.

11. The hand tool case as recited in claim 10, wherein the at least one first inductive charge receiving area is situated at least partially in immediate proximity to a wall.

12. The hand tool case as recited in claim 11, wherein the at least one first adjustment unit presses at least one hand tool battery which is inserted into the at least one first inductive charge receiving area against the wall.

13. The hand tool case as recited in claim 12, wherein the at least one first adjustment unit has at least one spring element.

14. The hand tool case as recited in claim 12, further comprising:
at least one second inductive charge receiving area.

15. The hand tool case as recited in claim 14, further comprising:
a second adjustment unit provided for changing at least one of a position and a size of the at least one second inductive charge receiving area.

16. The hand tool case as recited in claim 14, wherein the first adjustment unit simultaneously adjusts distances between (i) each one of two hand tool batteries which are situated in the first and second inductive charge receiving areas and (ii) the wall.

17. A system comprising:
a hand tool case having at least one first inductive charge receiving area and at least one first adjustment unit for changing at least one of a position and a size of at least the first inductive charge receiving area; and
at least one hand tool battery inserted into the at least one first inductive charge receiving area.
